(19) United States
(12) Patent Application Publication
(10) Pub. No.: US 2015/0021820 A1
(43) Pub. Date: Jan. 22, 2015

(54) METHOD FOR MAKING A WHEEL FOR HOT GLASS SHEET CONVEYANCE

(71) Applicant: GLASSTECH, INC., Perrysburg, OH (US)

(72) Inventors: Alfredo SERRANO, Maumee, OH (US); Thomas J. ZALESAK, Rossford, OH (US)

(21) Appl. No.: 14/507,090

(22) Filed: Oct. 6, 2014

Related U.S. Application Data
(62) Division of application No. 11/530,955, filed on Sep. 12, 2006, now abandoned.

(51) Int. Cl. C03B 35/18

(52) U.S. Cl. CPC C03B 35/188
USPC 264/269

(57) ABSTRACT

A method for making a wheel (60) for hot glass sheet conveyance is performed by providing an annular tire (64) of high temperature resistant synthetic resin (65) in which a woven material (74) is embedded, and by molding a synthetic thermoplastic resin (71) in situ within the tire to provide a rim (70) that supports the tire for rotation.

### CROSS-REFERENCE TO RELATED APPLICATIONS

This application is a divisional of U.S. application Ser. No. 11/530,955 filed on Sep. 12, 2006 by Alfredo Serrano and Thomas J. Zalesak under the title WHEEL AND ROLL ASSEMBLY FOR HOT GLASS SHEET CONVEYANCE, the disclosure of which is hereby incorporated in its entirety by reference herein.

### TECHNICAL FIELD

This invention relates to a method for making a wheel for hot glass sheet conveyance.

### BACKGROUND

U.S. Pat. No. 6,378,339 discloses a glass sheet forming system including roll assemblies that provide hot glass sheet forming and conveyance during the forming. The conveyance as disclosed is between a lower roll conveyor and an upper roll former which receive a hot glass sheet in a flat shape and are then curved to provide the glass sheet forming. Both the lower roll conveyor and the upper roll former include hot glass sheet roll assemblies which include wheels whose outer peripheries contact the glass sheet from below and above. These wheels have previously been make to include a center rim and an outer glass contacting portion that is made of a temperature resistant rope that is wrapped around the wheel and has ends secured within a radial opening in the rim to provide securement. Thus, the outer surface of such wheels does not have a 360° continuous surface for contacting the glass sheet being conveyed.

### SUMMARY

An object of the present invention is to provide an improved method for making a wheel for hot glass sheet conveyance.

In carrying out the above object, the method is performed by providing an annular tire of high temperature resistant synthetic resin of at least one aramid and having a central axis, with a woven material embedded within the high temperature resistant synthetic resin, with the annular tire having a round outer surface for contacting a hot glass sheet for conveyance, with the round outer surface having a round cylindrical shape extending parallel to the central axis, with the annular tire having a round inner surface defining an interior through which the central axis extends, and with the annular tire having opposite axial ends. A synthetic thermoplastic resin is molded in situ within the interior of the tire to provide a rim in supporting contact with the inner surface of the tire, with the rim being formed with a central opening that rotatably supports the wheel for rotation about the central axis, with the rim being molded with opposite axial ends including radial outer annular portions that are located closer to each other than the opposite axial ends of the tire, and with each axial end of the tire extending away from its other axial end past the adjacent radial outer annular portion of the molded rim in a cantilevered manner.

As disclosed, the rim is molded with the radial outer annular portions of the rim including axial grooves that extend axially toward each other.

In one practice of the method, the central opening of the rim is formed with a rotational driving shape, and in another practice of the method, the central opening of the rim is formed with a round shape.

The objects, features and advantages of the present invention are readily apparent from the following detailed description when taken in connection with the accompanying drawings.

### BRIEF DESCRIPTION OF THE DRAWINGS

FIG. 1 is a schematic side elevational view of a glass sheet forming system.

FIG. 2 is a sectional view taken along the direction of line 2-2 in FIG. 1 to illustrate a glass sheet forming station which includes lower and upper hot glass sheet roll assemblies having wheels made by the method of the invention.

FIG. 3 is a view similar to FIG. 2 but shown after the lower and upper roll assemblies have been moved from a straight shape to a curved shape to provide glass sheet forming.

FIG. 4 is a view of another embodiment similar to the one of FIGS. 2 and 3 but having upper wheels that are individually supported without being supported by a common shaft like the wheels of the lower roll assembly.

FIG. 5 is a longitudinal sectional view taken through one of the hot glass sheet roll assemblies to illustrate its construction and the construction of the wheel made by the method of the invention.

FIG. 6 is an enlarged view illustrating the resultant construction of the outer periphery of a wheel rim and an annular tire that extends around the rim.

FIG. 7 is an end view taken along the direction of line 7-7 in FIG. 5 to illustrate the construction of the wheel when it is made to provide rotational driving.

FIG. 8 is a partial view similar to FIG. 7 of another construction when the wheel is not made to be rotatively driven but rather to be freewheeling.

FIG. 9 is a schematic view illustrating a mold in which the wheel rim is molded in situ within the tire to provide the wheel manufacturing method.

### DETAILED DESCRIPTION

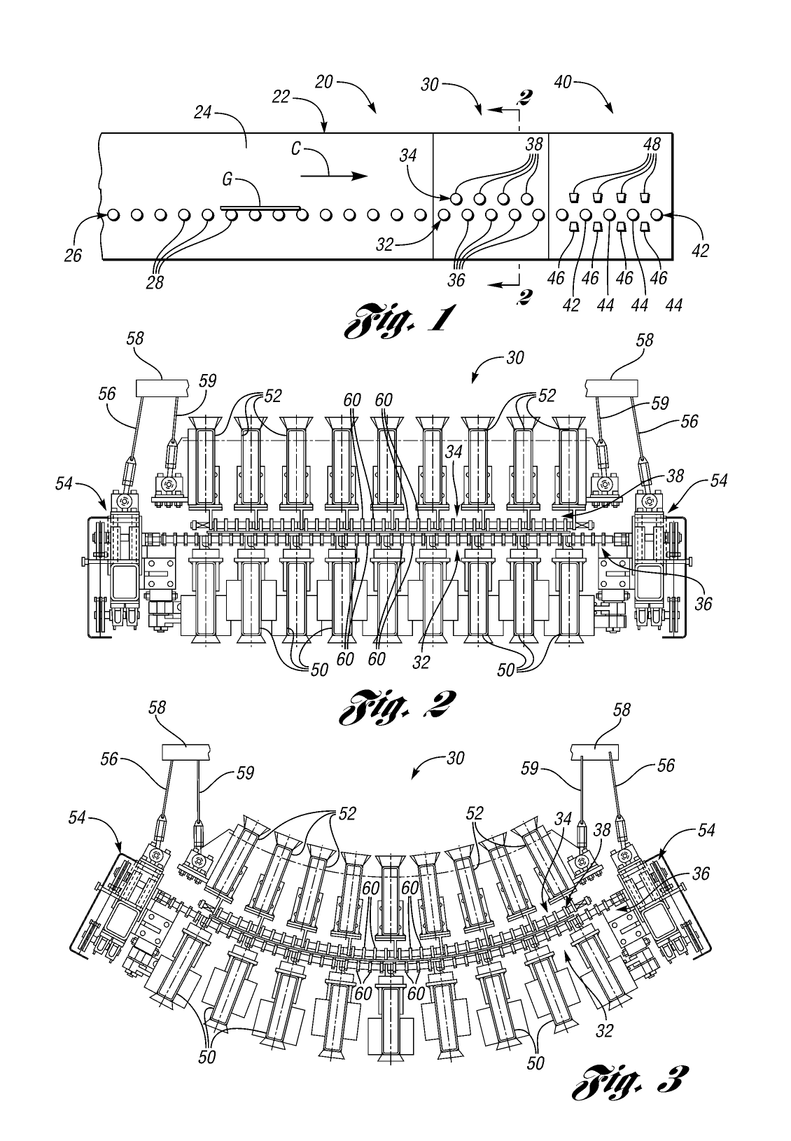

With reference to FIG. 1, a glass sheet forming system is generally indicated by 20 and includes a furnace 22 having a heating chamber 24 and a conveyor 26 that is located within the heating chamber to convey glass sheets G along a direction of conveyance shown by arrow C. As illustrated, the conveyor 26 includes rolls 28 that convey the glass sheets G through the heating chamber 24 for heating to a forming temperature. A forming station 30 of the system 20 is located downstream from the furnace 22 to receive the heated glass sheets for forming. More specifically, a lower roll conveyor 32 and an upper roll former 34 include hot glass sheet roll assemblies 36 and 38 respectively, which are constructed in accordance with the invention as is hereinafter more fully described. Glass sheet forming system 20 also includes a cooling station 40 having a conveyor 42 with rolls 44 for receiving the formed glass sheets. Lower and upper quench heads 46 and 48 of the cooling station respectively provide upwardly and downwardly directed quenching air to rapidly cool the formed glass sheets in order to improve their mechanical properties.

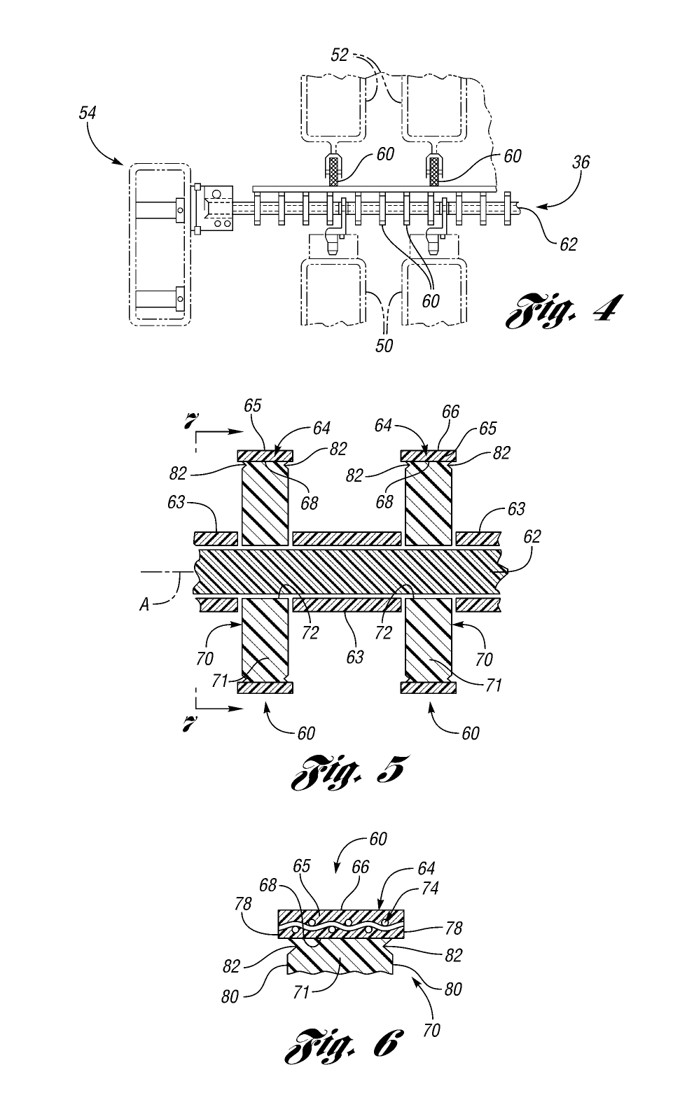

As illustrated in FIG. 2, the forming station 30 has its lower and upper hot glass sheet roll assemblies 36 and 38 supported by lower and upper elongated members 50 and 52, respectively, that extend along the direction of conveyance. The lower hot glass sheet roll assemblies 36 are rotatively driven by drive mechanisms 54 at the lateral sides of the system and are supported by suspension members 56 on a framework 58. The upper hot glass sheet roll assemblies 38, which are freewheeling and thus not rotatively driven, are mounted by the upper elongated members 52 which are supported at the opposite lateral sides of the system by suspension members 59 on the framework 58. The opposite upstream and downstream ends of the lower and upper elongated members 50 and 52 are supported by linkages in accordance with the teachings of U.S. Pat Nos. 5,498,275; 5,556,444; 5,697,999; and 6,378,339, the entire disclosures of which are hereby incorporated by reference. Suspension members 56 and 59 are operated to move the hot glass sheet roll assemblies 36 and 38 from their flat shape of FIG. 2 to their curved shape of FIG. 3 in order to provide the glass sheet forming. Both the lower and upper hot glass sheet roll assemblies 36 and 38 shown in FIGS. 2 and 3 have wheels 60 that are made by the method of the invention and are mounted by associated shafts 62 as illustrated in FIG. 5, and the wheels are spaced form each other by spacers 63 through which the shaft also extends. In the embodiment of FIG. 4, the lower hot glass sheet roll assemblies 36 also have wheels connected by shafts 62, but the upper wheels 60 are individually mounted on the associated upper elongated members 52.

With reference to FIGS. 5-8, each hot glass sheet roll assembly wheel 60 includes an annular tire 64 of a high temperature resistant synthetic resin 65 and has a central axis A that is also the same as the central axis A of shaft 62. The annular tire 64 has a round outer surface 66 for contacting glass sheets for conveyance, and the tire also has a round inner surface 68 defining an interior through which the central axis A extends. Each wheel 60 also includes a rim 70 of a synthetic resin 71 that is molded in situ within the interior of the tire 64 in supporting contact with the tire inner surface 68. The rim 70 has a central formation 72 that rotatively supports the wheel for rotation about the central axis A as described below.

The annular tire 64 of each wheel 60 as shown in FIG. 6 includes a woven material 74 embedded within the high temperature resistant synthetic resin 65 of the tire, and this synthetic resin forming the tire is preferably made with one or more aramids. Furthermore, the synthetic resin rim 70 is molded in situ within a mold 76 shown in FIG. 9 and is made from a high temperature resistant thermosetting resin.

As illustrated in FIGS. 5-7, the round outer surface 66 of each wheel tire 64 has a round cylindrical shape extending parallel to the central axis A. The tire 64 has opposite axial ends 78 between which its round outer surface 66 extends parallel to the central axis A with the round cylindrical shape. Furthermore, the rim 70 has opposite axial ends 80 which, as best illustrated in FIG. 6, have radial outer annular portions 82 which immediately adjacent the tire inner surface 68 are located axially closer to each other than the opposite axial ends 78 of the tire, such that each axial end 78 of the tire 64 extends from its other axial end past the radial outer annular portion 82 of the adjacent axial end 80 of the rim 70 in a cantilevered manner. This construction insures that the round outer surface 66 of the tire contacts the glass sheet along the entire width during the conveyance. Radial outer annular portions 82 of the rim as disclosed are embodied as axial grooves that extend axially toward each other and, as shown, have horizontal V shapes that point toward each other.

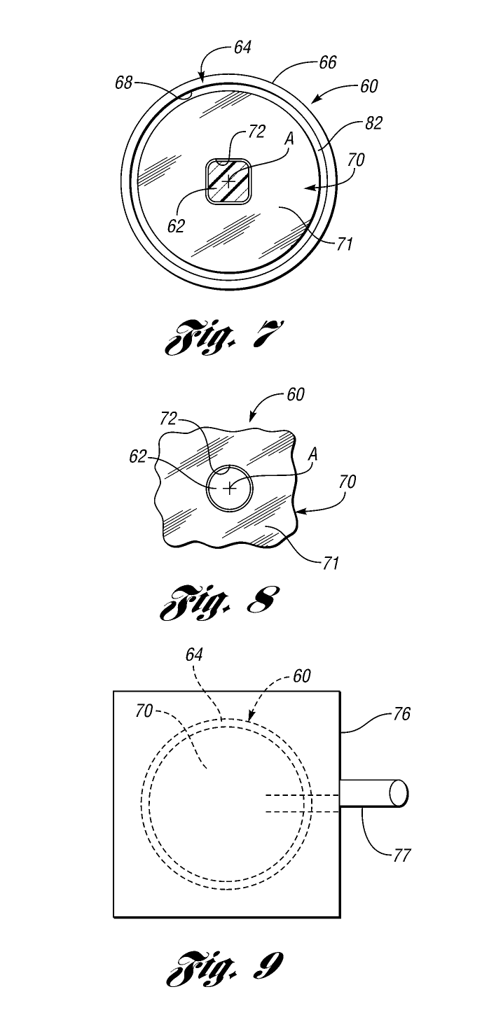

The wheels 60 utilized to provide rotational driving of the lower roll assemblies 36 have central formations 72 provided by openings which may have any rotational driving shape such as the somewhat square shape with rounded corners like their associated shaft 62 as illustrated in FIG. 7. Wheels that are freewheeling such as the wheels 60 utilized with the upper roll assemblies 38 may have round shapes like their associated shaft 62 such as illustrated in FIG. 8.

While different ways of practicing the invention have been illustrated and described, it is not intended that these ways illustrate and describe all possible ways of practicing the invention. Rather, the words used in the specification are words of description rather than limitation, and it is understood that various changes may be made without departing from the spirit and scope of the invention.

What is claimed is:

1. A method for making a wheel for hot glass sheet conveyance, the method comprising:
providing an annular tire of high temperature resistant synthetic resin of at least one aramid and having a central axis, with a woven material embedded within the high temperature resistant synthetic resin, with the annular tire having a round outer surface for contacting a hot glass sheet for conveyance, with the round outer surface having a round cylindrical shape extending parallel to the central axis, with the annular tire having a round inner surface defining an interior through which the central axis extends, and with the annular tire having opposite axial ends; and
molding a synthetic thermoplastic resin in situ within the interior of the tire to provide a rim in supporting contact with the inner surface of the tire, forming the rim with a central opening that rotatably supports the wheel for rotation about the central axis, with the rim being molded with opposite axial ends including radial outer annular portions that are located closer to each other than the opposite axial ends of the tire, and with each axial end of the tire extending away from its other axial end past the adjacent radial outer annular portion of the molded rim in a cantilevered manner.

2. A method for making a wheel for hot glass sheet glass conveyance as is claim 1 wherein the rim is molded with the radial outer annular portions of the rim including axial grooves that extend axially toward each other.

3. A method for making a wheel for hot glass sheet glass conveyance as is claim 1 wherein the central opening of the rim is formed with a rotational driving shape.

4. A method for making a wheel for a hot glass sheet glass conveyance as is claim 1 wherein the central opening of the rim is formed with a round shape.

5. A method for making a wheel for hot glass sheet conveyance, the method comprising:
providing an annular tire of high temperature resistant synthetic resin of at least one aramid and having a central axis, with a woven material embedded within the high temperature resistant synthetic resin, with the annular tire having a round outer surface for contacting a hot glass sheet for conveyance, with the round outer surface having a round cylindrical shape extending parallel to the central axis, with the annular tire having a round inner surface defining an interior through which the central axis extends, and with the annular tire having opposite axial ends; and
molding a synthetic thermoplastic resin in situ within the interior of the tire to provide a rim in supporting contact with the inner surface of the tire, forming the rim with a central opening that rotatably supports the wheel for rotation about the central axis and has either a rotational driving shape or a round shape, with the rim being molded with opposite axial ends including radial outer annular portions that are located closer to each other than the opposite axial ends of the tire and that include axial grooves that extend axially toward each other, and with each axial end of the tire extending away from its other axial end past the adjacent radial outer annular portion of the molded rim in a cantilevered manner.
